(19) United States
(12) Patent Application Publication
(10) Pub. No.: US 2024/0210101 A1
(43) Pub. Date: Jun. 27, 2024

(54) REFRIGERATOR AND METHOD FOR CONTROLLING REFRIGERATOR

(71) Applicant: Samsung Electronics Co., Ltd., Suwon-si (KR)

(72) Inventors: Sangyong LEE, Suwon-si (KR); Jueon KIM, Suwon-si (KR); Jihyung HA, Suwon-si (KR); Jangwoo LEE, Suwon-si (KR); Kyungah CHANG, Suwon-si (KR)

(73) Assignee: Samsung Electronics Co., Ltd., Suwon-si (KR)

(21) Appl. No.: 18/599,565

(22) Filed: Mar. 8, 2024

Related U.S. Application Data
(63) Continuation of application No. PCT/KR2022/013850, filed on Sep. 16, 2022.

(30) Foreign Application Priority Data
Oct. 15, 2021 (KR) 10-2021-0137141

(51) Int. Cl. F25D 29/00; E05F 15/73

(52) U.S. Cl. CPC F25D 29/00; E05F 15/73; E05F 2015/765; E05F 2015/767; E05Y 2900/31; F25D 2323/021; F25D 2400/361; F25D 2700/04

(57) ABSTRACT

A refrigerator capable of automatically opening and closing a door is provided. In particular, there is provided a refrigerator that detects a gaze point of a user by using image data of the user obtained by an image obtaining sensor, determines a door corresponding to the gaze point of the user, and opens the determined door by controlling a door driving unit.

### CROSS-REFERENCE TO RELATED APPLICATIONS

This application is a continuation of International Application PCT/KR2022/013850, filed Sep. 16, 2022, which is incorporated herein by reference in its entirety, and claims foreign priority to Korean application 10-2021-0137141, filed Oct. 15, 2021, which is incorporated herein by reference in its entirety.

### TECHNICAL FIELD

The present disclosure relates to a refrigerator that automatically opens and closes a door and a control method of the refrigerator.

### BACKGROUND ART

A refrigerator is an electronic device capable of storing objects in a low-temperature storage compartment (or storage space). The refrigerator may include one or more doors depending on the number or structure of storage compartments. A door included in the refrigerator is used when loading or unloading objects into or from the storage compartment, and when closed, the door prevents cold air from leaking out of the storage compartment and maintains a constant temperature inside the storage compartment.

An opening and closing operation of a door of such a refrigerator is performed via separate user manipulation based on a user's physical contact. However, as functions of refrigerators become smarter, refrigerators are being proposed which are capable of opening and closing a door based on a user's intention without any separate manipulation by the user.

### DISCLOSURE

### Technical Solution

A refrigerator according to an embodiment of the present disclosure may include a main body, at least one door rotatably coupled to a front of the main body, a door driving unit configured to automatically open and close the at least one door, an image obtaining sensor configured to obtain image data of a user located in the vicinity of the refrigerator, and at least one processor. According to an embodiment of the present disclosure, the at least one processor may be configured to detect a gaze point where a gaze of the user stays for a preset time period or longer by using the obtained image data of the user, determine a door corresponding to the detected gaze point among the at least one door, and control the door driving unit to open the determined door.

A control method of a refrigerator according to an embodiment of the present disclosure may include obtaining image data of a user located in a vicinity of the refrigerator by using an image obtaining sensor included in the refrigerator, detecting a gaze point where a gaze of the user stays for a preset time period or longer by using the obtained image data of the user, determining a door corresponding to the detected gaze point of the user among at least one door included in the refrigerator, and opening the determined door by controlling the door driving unit included in the refrigerator.

### DESCRIPTION OF DRAWINGS

FIG. 1 is a diagram illustrating a refrigerator according to an embodiment of the present disclosure.

FIG. 2 is a block diagram illustrating functions of a refrigerator according to an embodiment of the present disclosure.

FIG. 3 is an exemplary diagram illustrating locations where an image obtainer included in a refrigerator can be mounted, according to an embodiment of the present disclosure.

FIG. 4 is an exemplary diagram illustrating locations where an image obtainer is arranged when a refrigerator has one door or at least one sliding-based drawer, according to an embodiment of the present disclosure.

FIG. 5 is an exemplary diagram illustrating a shape of an eyeball extracted from image data obtained by an image obtainer, according to an embodiment of the present disclosure.

FIG. 6 is an exemplary diagram illustrating a relationship between two-dimensional (2D) plane coordinate values of a refrigerator and a gaze area, according to an embodiment of the present disclosure.

FIG. 7 is an exemplary diagram illustrating a location of a door driving unit mounted on a refrigerator, according to an embodiment of the present disclosure.

FIG. 8 is a block diagram illustrating functions of a refrigerator according to an embodiment of the present disclosure.

FIG. 9 is an exemplary diagram of a refrigerator equipped with an image obtainer and a sensor of FIG. 8.

FIG. 10 is a block diagram illustrating functions of a refrigerator according to an embodiment of the present disclosure.

FIG. 11 is an example of providing guidance information regarding a door to be opened via an output unit included in a refrigerator, according to an embodiment of the present disclosure.

FIG. 12 is a block diagram illustrating functions of processors included in a refrigerator, according to an embodiment of the present disclosure.

FIG. 13 is a flowchart illustrating a control method of a refrigerator, according to an embodiment of the present disclosure.

FIG. 14 is a flowchart illustrating a control method of a refrigerator, according to an embodiment of the present disclosure.

FIG. 15 is a flowchart illustrating a control method of a refrigerator, according to an embodiment of the present disclosure.

FIG. 16 is a flowchart illustrating a control method of a refrigerator, according to an embodiment of the present disclosure.

FIG. 17 is a flowchart illustrating a control method of a refrigerator, according to an embodiment of the present disclosure.

FIG. 18 is a flowchart illustrating a control method of a refrigerator, according to an embodiment of the present disclosure.

### MODE FOR INVENTION

Terms used in the present disclosure will be briefly described, and then an embodiment of the present disclosure will be described in detail.

As the terms used in the present disclosure, general terms that are currently widely used are selected by taking functions according to an embodiment of the present disclosure into account, but the terms may be changed according to the intention of one of ordinary skill in the art, precedent cases, advent of new technologies, or the like. Furthermore, specific terms may be arbitrarily selected by the applicant, and in this case, the meaning of the selected terms will be described in detail in the detailed description of an embodiment of the present disclosure. Thus, the terms used in the present disclosure should be defined not by simple appellations thereof but based on the meaning of the terms together with the overall description of the present disclosure.

Throughout the specification, when a part “includes” or “comprises” an element, unless there is a particular description contrary thereto, it is understood that the part may further include other elements, not excluding the other elements. In addition, terms such as “portion”, “module”, etc., described in the specification refer to a unit for processing at least one function or operation and may be implemented as hardware or software, or a combination of hardware and software.

Embodiments of the present disclosure will be described more fully hereinafter with reference to the accompanying drawings so that they may be easily implemented by one of ordinary skill in the art of the present disclosure. However, an embodiment of the present disclosure may be implemented in different forms and should not be construed as being limited to embodiments set forth herein. In addition, parts not related to descriptions are omitted to clearly describe an embodiment of present disclosure in the drawings, and like reference numerals denote like elements throughout.

According to an embodiment of the present disclosure, there may be provided a refrigerator and control method thereof for automatically opening and closing a door as desired by a user, based on eye tracking for the user.

According to an embodiment of the present disclosure, there may be provided a refrigerator and control method thereof for automatically opening and closing a door as desired by the user, based on the user's location and tracking of the user's eyes.

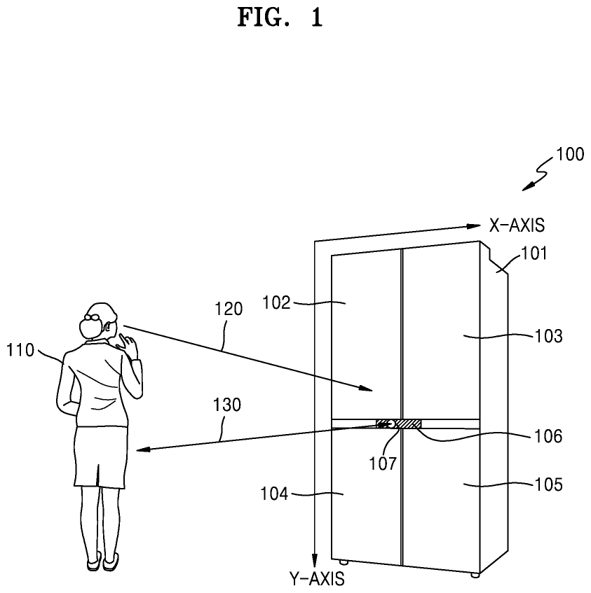

FIG. 1 is a diagram illustrating a refrigerator according to an embodiment of the present disclosure.

A refrigerator 100 according to an embodiment of the present disclosure may include a main body 101, first to fourth doors 102 to 105, an image obtainer 106, and a sensor 107. The number of doors included in the refrigerator 100 is not limited to that shown in FIG. 1. For example, the refrigerator 100 may include one or more doors. Furthermore, a door of the refrigerator 100 may be configured as a glass door that allows an interior to be seen with the naked eye from outside the door, or may be configured as an opaque door that does not allow the interior to be seen with the naked eye from outside the door. The door of the refrigerator 100 may be configured in a hinged form or sliding form. The refrigerator 100 may include hinges that rotatably couple the first to fourth doors 102 to 105 to a front of the main body 101.

The refrigerator 100 shown in FIG. 1 may include a plurality of storage compartments that may be respectively sealed by the first to fourth doors 102 to 105. A storage compartment may be set as a freezing compartment or refrigerating compartment to store objects. A refrigerating compartment may refer to a storage compartment capable of storing objects at a temperature of, for example, about 0 degree Celsius to about 5 degrees Celsius, but the temperature of the refrigerating compartment is not limited thereto. A freezing compartment may refer to a storage space capable of storing objects at a temperature of, for example, about minus 30 degrees Celsius to about 0 degree Celsius, but the temperature of the freezing compartment is not limited thereto. For example, the refrigerating compartment and the freezing compartment may each be operated by selecting a temperature range from among a plurality of temperature ranges.

The main body 101 of the refrigerator 100 may have a box shape and have an open front. The main body 101 of the refrigerator 100 may include an insulating material. Opening and closing operations of the first to fourth doors 102 to 105 are performed to open or close storage compartments provided in the main body 101. To prevent cold air from leaking out of the storage compartments provided in the main body 101 in a state in which the first to fourth doors 102 to 105 are closed, a filler and/or a sealing member may be included between the main body 101 and each of the first to fourth doors 102 to 105. The filler or sealing member may be composed of a rubber material. The storage compartments may also be provided in the first to fourth doors 102 to 105. The storage compartments provided in the first to fourth doors 102 to 105 may be configured in the form of door shelves.

The image obtainer 106 may be used to track a gaze 120 (e.g., a gaze direction) of a user 110. The image obtainer 106 may be configured as an image obtaining sensor for tracking the gaze 120 (e.g., gaze direction) of the user 110. The refrigerator 100 may track the gaze 120 of the user 110 based on image data obtained using the image obtainer 106 to determine a door the user 110 desires to open, automatically open the determined door, and close the opened door.

In order to determine which of the first to fourth doors 102 to 105 is to be opened based on a gaze point of the user 110 detected by tracking the gaze 120 of the user 110, the refrigerator 100 may have two-dimensional (2D) plane coordinate values (x, y) for the front of the main body 101. The gaze point of the user 110 detected by tracking the gaze 120 of the user 110 is a point (or a location) on the front of the refrigerator 100 at which the user's gaze stays for a preset time period or longer, and may be represented by 2D plane coordinate values (x,y). The gaze point of the user may be referred to as a viewpoint. The preset time period may be stored in the refrigerator 100 when the refrigerator 100 is manufactured, or may be set by the user 110.

The refrigerator 100 may detect a distance value between the user 110 and the refrigerator 100 by using the sensor 107. The refrigerator 100 may determine, based on the detected distance value, the user's intention to open at least one door of the refrigerator 100. The distance value between the user 110 and the refrigerator 100 may represent a distance value between a current location of the user 110 and the front of the refrigerator 100.

The sensor 107 is used to detect a distance value 130 between the user 110 and the refrigerator 100. When the distance value between the front of the refrigerator 100 and the current location of the user 110 satisfies a preset distance condition by using a value sensed using the sensor 107, the refrigerator 100 may track the gaze of the user 110 by activating an operation of the image obtainer 106. The refrigerator 100 may determine a door to be opened based on a result of the tracking. The refrigerator 100 may open the determined door and close the opened door. The preset distance condition may refer to a condition under which it is determined that the user 110 has the intention to open a door of the refrigerator 100 while preventing a collision between the door of the refrigerator 100 and a body of the user 110 when opening or closing the door of the refrigerator 100. For example, the preset distance condition may be a condition in which a distance value between the front of the refrigerator 100 and the current location of the user 110 is set to be greater than or equal to 30 cm and less than 60 cm, but is not limited thereto.

According to an embodiment of the present disclosure, the refrigerator 100 may determine a door that the user 110 desires to open based on the result of tracking eyes of the user 110 by using the image obtainer 106. After opening the determined door, the refrigerator 100 may close the opened door when a certain time period has elapsed. Therefore, according to an embodiment of the present disclosure, the door of the refrigerator 100 may be opened automatically according to a gaze of the user 110, which may increase convenience for the user 110. In particular, a door of the refrigerator 100 may be opened automatically even if the user 110 does not pull a handle to open the door of the refrigerator 100, and thus may be useful for users with a weak hand grip strength.

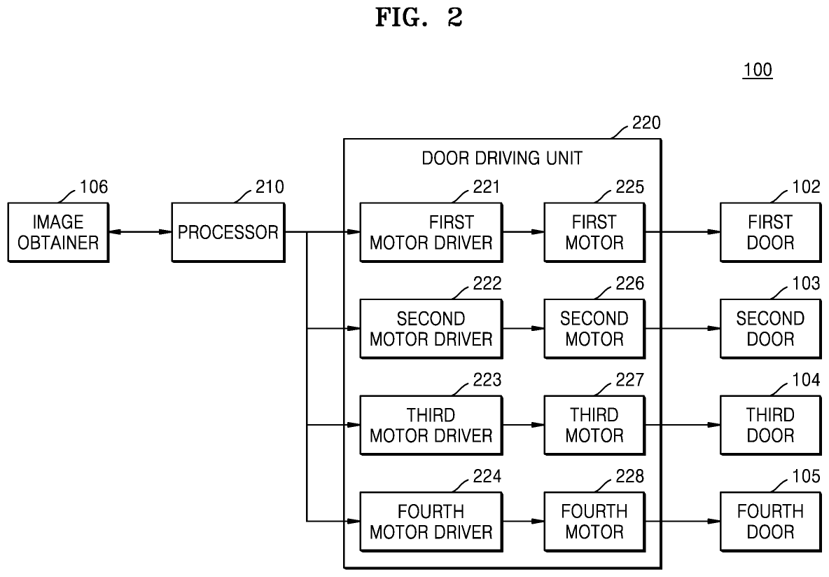

FIG. 2 is a block diagram illustrating functions of a refrigerator according to an embodiment of the present disclosure.

Referring to FIG. 2, the refrigerator 100 includes the image obtainer 106, a processor 210, a door driving unit 220, and the first to fourth doors 102 to 105, but the components included in the refrigerator 100 according to the embodiment of the present disclosure are not limited to those shown in FIG. 2. For example, hinges coupling the main body 101 of the refrigerator 100 to the first to fourth doors 102 to 105, storage compartments provided in the main body 101, etc. are components included in the refrigerator 100 although not shown for convenience of description.

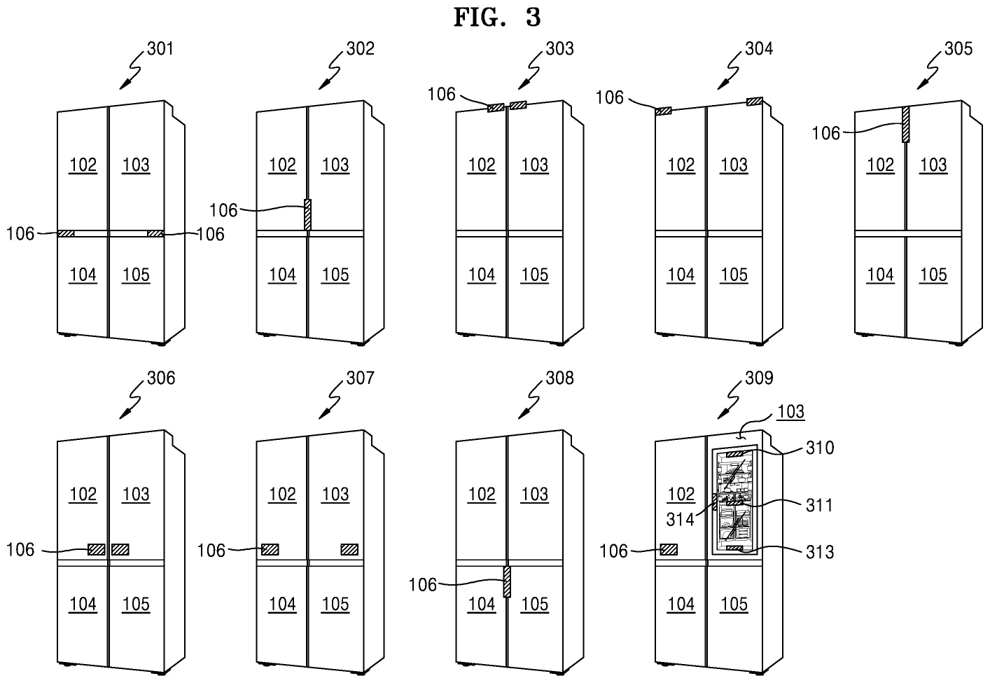

The image obtainer 106 obtains image data of the user 110 located near the refrigerator 100 in order to track a gaze of the user 110. The image obtainer 106 may be referred to as an image obtaining sensor. The image obtainer 106 may be mounted at least one location on the front of the refrigerator 100. For example, the image obtainer 106 may be mounted on a central frame of the refrigerator 100 as shown in FIG. 1 or may be mounted at locations 301 to 309 of FIG. 3.

FIG. 3 is an exemplary diagram illustrating locations where the image obtainer 106 included in the refrigerator 100 can be mounted, according to an embodiment of the present disclosure. Referring to FIG. 3, the image obtainer 106 may be arranged at least one location on a front frame of the refrigerator 100 or on a front surface of at least one of the first to fourth doors 102 to 105.

For example, referring to 301 of FIG. 3, the image obtainer 10 may be located at a left portion between the first door 102 and the third door 104 and a right portion between the second door 103 and the fourth door 105. Referring to 302 of FIG. 3, the image obtainer 106 may be located at a lower portion between the first door 102 and the second door 103. Referring to 303 of FIG. 3, the image obtainer 106 may be located at a top right portion of the first door 102 and a top left portion of the second door 103. Referring to 304 of FIG. 3, the image obtainer 106 may be located at a top left portion of the first door 102 and a top right portion of the second door 103. Referring to 305 of FIG. 3, the image obtainer 106 may be located at an upper portion between the first door 102 and the second door 103. Referring to 306 of FIG. 3, the image obtainer 106 may be located at a bottom right corner of a front surface of the first door 102 and a bottom left corner of a front surface of the second door 103. Referring to 307 of FIG. 3, the image obtainer 106 may be located at a bottom left corner of the front surface of the first door 102 and a bottom right corner of the front surface of the second door 103. Referring to 308 of FIG. 3, the image obtainer 106 may be located at a bottom right corner of a front between the third door 104 and the fourth door 105 and a bottom left corner of the front surface of the second door 103. When the door of the refrigerator 100 is a glass door as shown in 309 of FIG. 3, the image obtainer 106 may be arranged in a direction from an inside of the glass door toward an outside of the glass door. For example, the image obtainer 106 may be arranged at least one of an upper central portion 310, a left central portion 314, a central portion 311, and a lower central portion 313 of the inner side of the glass door. The locations where the image obtainer 106 included in the refrigerator 100 is arranged according to an embodiment of the present disclosure is not limited to those described above.

Although FIG. 3 illustrates the locations where the image obtainer 106 included in the refrigerator 100 is arranged, the sensor 107 may be arranged at a location close to the image obtainer 106.

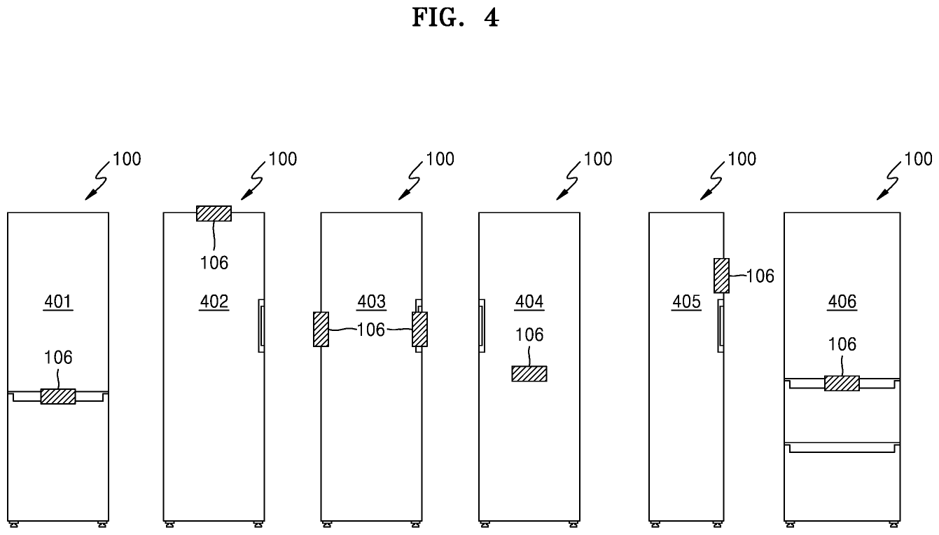

FIG. 4 is an exemplary diagram illustrating locations where the image obtainer 106 is arranged when the refrigerator 100 includes one door or at least one sliding-based drawer, according to an embodiment of the present disclosure.

401 of FIG. 4 shows an example in which the refrigerator 100 includes one door, and has the image obtainer 106 located at a central portion of a door handle. 402 of FIG. 4 shows an example in which the refrigerator 100 includes one door, and has the image obtainer 106 located at a top central portion of the door. 403 of FIG. 4 shows an example in which the refrigerator 100 includes one door and has image obtainers 106 arranged at a location close to a left center of the door and at a right handle. 404 of FIG. 4 shows an example in which the refrigerator 100 includes one door, and has the image obtainer 106 arranged at a location close to a center of a front surface of the door. 405 of FIG. 4 shows an example in which the refrigerator 100 includes one door, and has the image obtainer 106 located above a right handle of the door. 406 of FIG. 4 shows an example in which the refrigerator 100 includes one door and two drawers at a bottom thereof and has the image obtainer 106 located at a central portion of a top drawer. At least one of the drawers in 406 of FIG. 4 may be configured as a sliding-based drawer, but is not limited thereto. Although FIG. 4 shows the locations where the image obtainer 106 included in the refrigerator 100 is arranged, the sensor 107 may be arranged at a location close to the image obtainer 106.

The image obtainer 106 may obtain image data of the user 110 located near the refrigerator 100 or the door of the refrigerator 100 in various ways. For example, when the image obtainer 106 is configured to perform eye tracking by using an infrared tracking method, the image obtainer 106 may include a camera and an infrared or near-infrared lighting device. The infrared or near-infrared lighting device may be located in close proximity to the camera. When the image obtainer 106 includes the camera and the infrared or near-infrared lighting device, the image obtainer 106 may obtain black-and-white image data of the user 110, captured by using the camera, while emitting infrared or near-infrared light toward the user 110.

For example, when the image obtainer 106 performs eye tracking by using a red green blue (RGB) camera tracking method, the image obtainer 106 may include an RGB camera and an infrared or near-infrared lighting device. When the image obtainer 106 includes the camera and the infrared or near-infrared lighting device, the image obtainer 106 may obtain color image data of the user 110, captured by using the RGB camera, while emitting infrared or near-infrared light toward the user 110.

The image obtainer 106 may further include a tilt controller that recognizes a moving object and automatically performs a tilt control for the camera within a preset angle range according to a direction in which the object moves. The image obtainer 106 may consist of only a camera. When the image obtainer 106 consists of only a camera, the camera may have the eye-tracking function described above. Accordingly, the image obtainer 106 may be referred to as a camera.

When image data of the user 110 obtained by the image obtainer 106 is received, the processor 210 detects a gaze vector of the user 110. In order to detect the gaze vector of the user 110, the processor 210 detects a face region of the user 110 in the received image data of the user 110 and recognizes contours of a face from the detected face region of the user 110 to detect an orientation of the face, a shape of eyes, and a shape of eyeballs. To detect a shape of eyeballs from the received image data of the user 110, the processor 210 may use a face recognition program.

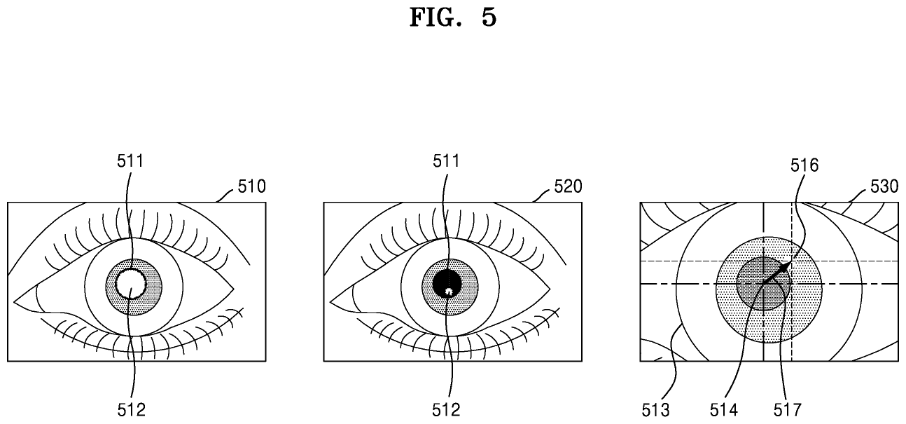

When the image obtainer 106 is configured to use an infrared tracking method, the processor 210 may detect eyeball shapes 510 and 520 as shown in FIG. 5, and detect a gaze vector of the user 110 by tracking the movement and orientation of the pupils 511 based on light obtained when infrared/near infrared light 512 included in the detected eyeball shapes 510, 520 is reflected off the pupils 511. FIG. 5 is an exemplary diagram illustrating an eyeball shape extracted from image data obtained by the image obtainer 106, according to an embodiment of the present disclosure.

When the image obtainer 106 uses an RGB camera, the processor 210 detects an eyeball shape 530 as shown in FIG. 5. The processor 210 detects a center 514 of an iris 513 and a glint 516 of light reflected off a cornea, which are included in the detected eyeball shape 530. The processor 210 detects a gaze vector of the user 110 by using a vector value 517 between the center 514 of the iris 513 and the glint 516 of light. The gaze vector of the user 110 may represent a direction and magnitude of a gaze from the eyeballs of the user 110 to the front of the refrigerator 100.

When the gaze vector of the user 110 is detected, the processor 210 detects 2D plane coordinate values of the front of the refrigerator 100 based on the detected gaze vector. The detected 2D plane coordinate values of the front of the refrigerator 100 may be referred to as a gaze point of the user 110.

According to an embodiment of the present disclosure, the processor 210 may divide the front of the refrigerator 100 into a plurality of virtual areas and define the plurality of virtual areas as gaze areas. For example, based on the number of doors of the refrigerator 100 or a structure of the refrigerator 100, the processor 210 may divide the front of the refrigerator 100 into six areas, four areas, three areas, or two areas. Moreover, the processor 210 may divide the front of the refrigerator 100 into a plurality of virtual areas based on an input by the user 110. For example, the processor 210 may divide the front of the refrigerator 100 into six areas, four areas, three areas, or two areas according to an input by the user 110.

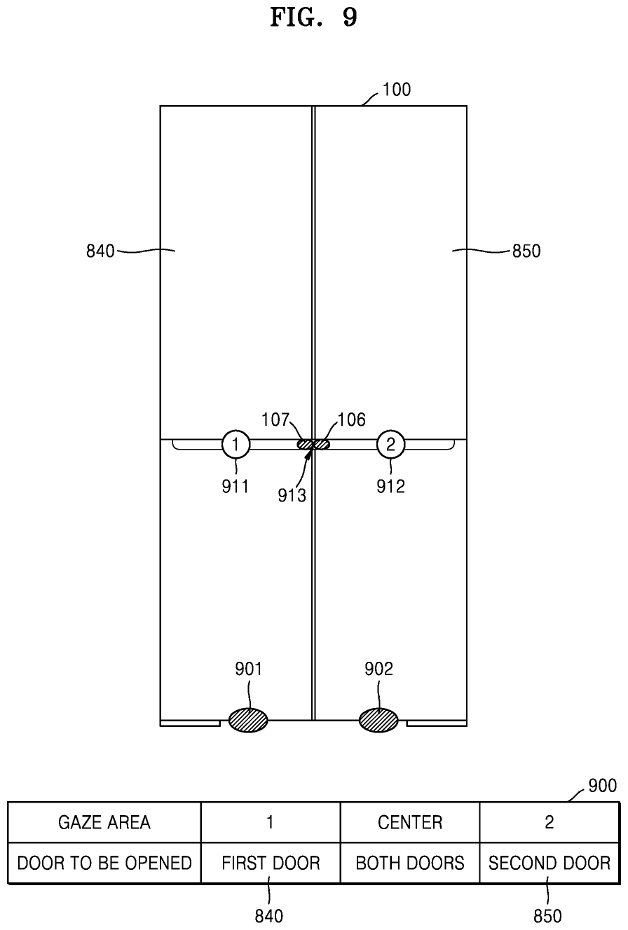

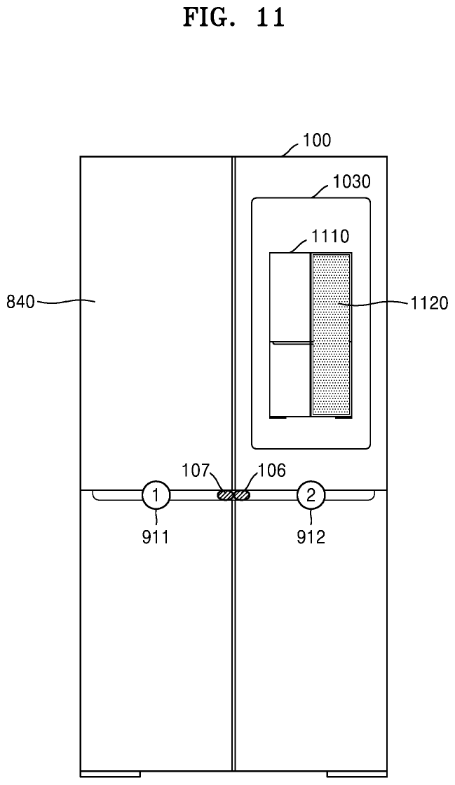

According to an embodiment of the present disclosure, the processor 210 may divide the entire front of the refrigerator 100 into a plurality of areas and define all of the plurality of areas as gaze areas. Furthermore, the processor 210 may define only a portion of the front of the refrigerator 100 as gaze areas. An operation in which the processor 210 defines a portion of the front of the refrigerator as gaze areas is described later with reference to FIG. 9. In the case of a door included in the refrigerator 100, which includes a display-based output unit 1030 on a front surface thereof as shown in FIG. 11, the processor 210 may exclude a region of the front surface of the door where the output unit 1030 is disposed from a gaze area. When the output unit 1030 is configured based on a display, the output unit 1030 may be referred to as a display.

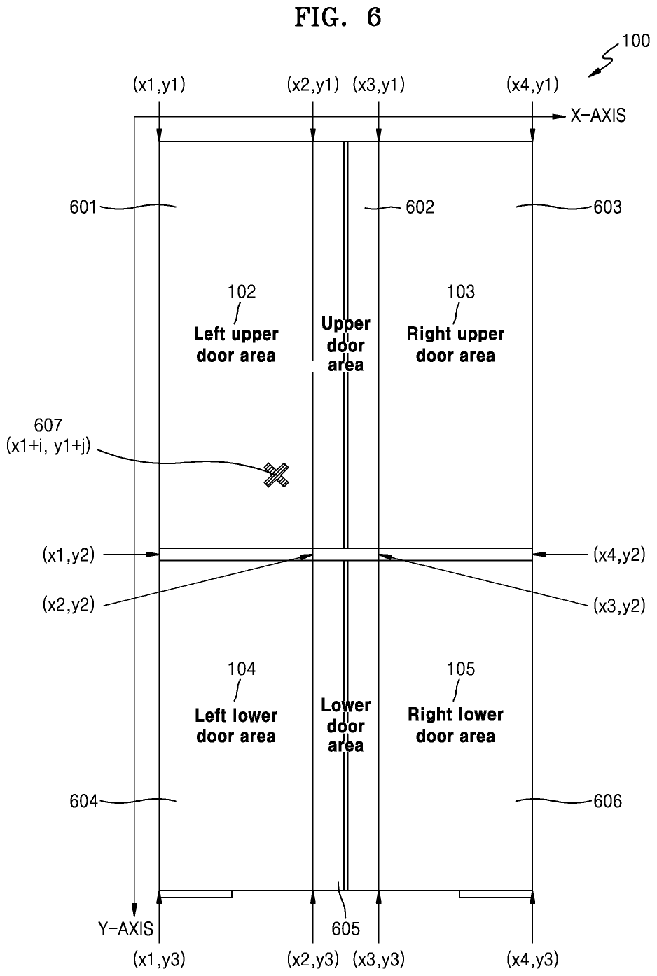

FIG. 6 is an exemplary diagram illustrating a relationship between 2D plane coordinate values of the refrigerator 100 and a gaze area when the front of the refrigerator 100 is divided into six areas. Referring to FIG. 6, the refrigerator 100 includes the first to fourth doors 102 to 105, and the front of the refrigerator 100 is defined as first to sixth gaze areas 601 to 606.

The processor 210 may previously have 2D plane coordinate values for each of the first to sixth gaze areas 601 to 606 shown in FIG. 6. For example, as shown in FIG. 6, 2D plane coordinate values for the first gaze area 601 of the refrigerator 100 are from a point (x1, y1) to a point (x2, y2). 2D plane coordinate values for the second gaze area 602 for the refrigerator 100 are from a point (x2, y1) to a point (x3, y2). 2D plane coordinate values for the third gaze area 603 of the refrigerator 100 are from a point (x3, y1) to a point (x4, y2). 2D plane coordinate values for the fourth gaze area 604 of the refrigerator 100 are from a point (x1, y2) to a point (x2, y3). 2D plane coordinate values for the fifth gaze area 605 of the refrigerator 100 are from a point (x2, y2) to a point (x3, y3). 2D plane coordinate values for the sixth gaze area 606 of the refrigerator 100 are from a point (x3, y2) to a point (x4, y3). The first gaze area 601 may be referred to as a left upper door area of the refrigerator 100. The second gaze area 602 may be referred to as an upper door area of the refrigerator 100. The third gaze area 603 may be referred to as a right upper door area of the refrigerator 100. The fourth gaze area 604 may be referred to as a left lower door area of the refrigerator 100. The fifth gaze area 605 may be referred to as a lower door area of the refrigerator 100. The sixth gaze area 606 may be referred to as a right lower door area of the refrigerator 100.

The 2D plane coordinate values of the first to sixth gaze areas 601 to 606 may be stored in a memory 1020 provided separately from the processor 210. When the 2D plane coordinate values of the first to sixth gaze areas 601 to 606 are stored in the memory 1020, the processor 210 may read and use the 2D plane coordinate values of the first to sixth gaze areas 601 to 606 stored in the memory 1020. The 2D plane coordinate values of a gaze area of the refrigerator 100 may be set differently depending on the number of doors of the refrigerator 100. For example, when a gaze point detected based on eye tracking for the user 110 is detected as a point 607 having 2D plane coordinate values (x1+i, y1+j), the processor 210 may detect the first gaze area 601 including the gaze point 607 of the user 110 as a gaze area corresponding to the gaze point 607.

As described above, the processor 210 tracks a gaze of the user 110 based on the image data of the user 110 received from the image obtainer 106. The processor 210 may use an eye tracking program or an eye tracking application to detect a gaze area including a tracked gaze point of the user 110. The eye tracking program or eye tracking application may be stored in the memory 1020 provided separately from the processor 210 and used by the processor 210. Detecting a gaze direction of the user 110 may be referred to as including converting a coordinate system of the camera included in the image obtainer 106, which captures images of pupils of the user 110, to a coordinate system of the gaze point of the user 110 on the refrigerator 100.

When coordinate values for a gaze area of the refrigerator 100 are detected, the processor 210 may detect a gaze area including the gaze point of the user 110 among the first to fourth doors 102 to 105 based on the detected coordinate values, and determine a door based on the detected gaze area. For example, when the gaze point of the user 110 is detected to be included in the first gaze area 601, the processor 210 determines the first door 102 as the door to be opened. When the gaze point of the user 110 is detected to be included in the second gaze area 602, because the second gaze area 602 is a boundary area between the first door 102 and the second door 103, the processor 210 determines the first door 102 and the second door 103 adjacent to the boundary area as the doors to be opened. When the gaze point of the user 110 is detected to be included in the third gaze area 603, the processor 210 determines the second door 103 as the door to be opened. When the gaze point of the user 110 is detected to be included in the fourth gaze area 604, the processor 210 determines the third door 104 as the door to be opened. When the gaze point of the user 110 is detected to be included in the fifth gaze area 605, because the fifth gaze area 605 is a boundary area between the third door 104 and the fourth door 105, the processor 210 determines the third door 104 and the fourth door 105 adjacent to the boundary area as the doors to be opened. When the gaze point of the user 110 is determined to be included in the sixth gaze area 606, the processor 210 determines the fourth door 105 as the door to be opened.

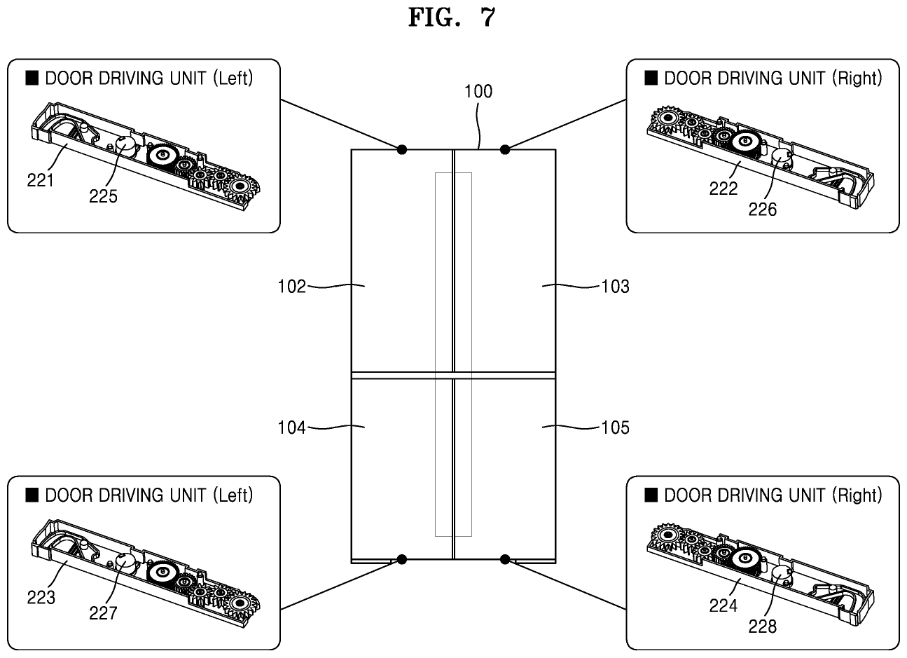

When the processor 210 determines the door to be opened, the processor 210 transmits a control signal for opening the determined door to the door driving unit 220. Transmitting, by the processor 210, a control signal for opening the determined door to the door driving unit 220 means that the door driving unit 220 is controlled by the processor 201. Therefore, in the following description, the transmission of a control signal for opening the door from the processor 210 to the door driving unit 220 may indicate that the processor 210 controls the door driving unit 220 to open the door. Additionally, the transmission of a control signal for closing the door from the processor 210 to the door driving unit 220 may indicate that the processor 210 controls the door driving unit 220 to close the door. The door driving unit 220 shown in FIG. 2 includes, but is not limited to, first to fourth motor drivers 221, 222, 223, and 224 and first to fourth motors 225, 226, 227, and 228 that respectively automatically drive the opening and closing of the first to fourth doors 102 to 105. The door driving unit 220 may be arranged at a location as shown in FIG. 7, but is not limited thereto.

FIG. 7 is an exemplary diagram illustrating a location of the door driving unit 220 mounted on the refrigerator 100, according to an embodiment of the present disclosure. FIG. 7 is an example of the door driving unit 220 including the first to fourth motor drivers 221 to 224 and the first to fourth motors 225 to 228 arranged at different positions to respectively open and close the first to fourth doors 102 to 105. For example, the first motor driver 221 and the first motor 225 may be disposed on a portion of a top frame of the refrigerator 100 close to an upper side of the first door 102. The second motor driver 222 and the second motor 226 may be disposed on a portion of the top frame of the refrigerator 100 close to an upper side of the second door 103. The third motor driver 223 and the third motor 227 may be disposed on a portion of a bottom frame of the refrigerator 100 close to a lower side of the third door 104. The fourth motor driver 224 and the fourth motor 228 may be disposed on a portion of the bottom frame of the refrigerator 100 close to a lower side of the fourth door 105.

When receiving a control signal for opening a determined door from the processor 210, the door driving unit 220 opens the corresponding door. When the door to be opened is the first door 102, the control signal transmitted from the processor 210 to the door driving unit 220 may represent a control signal for activating operations of the first motor driver 221 and the first motor 225 and deactivating operations of the second to fourth motor drivers 222 to 224 and the second to fourth motors 226 to 228. When the door to be opened is the second door 103, the control signal transmitted from the processor 210 to the door driving unit 220 may represent a control signal for activating operations of the second motor driver 222 and the second motor 226 and deactivating operations of the first, third, and fourth motor drivers 221, 223, and 224 and the first, third, and fourth motors 225, 227, and 228. When the door to be opened is the third door 104, the control signal transmitted from the processor 210 to the door driving unit 220 may represent a control signal for activating operations of the third motor driver 223 and the third motor 227 and deactivating operations of the first, second, and fourth motor drivers 221, 222, and 224 and the first, second, and fourth motors 225, 226, and 228. When the door to be opened is the fourth door 105, the control signal transmitted from the processor 210 to the door driving unit 220 may represent a control signal for activating operations of the fourth motor driver 224 and the fourth motor 228 and deactivating operations of the first to third motor drivers 221 to 223 and the first to third motors 225 to 227.

The processor 210 may detect an area where a gaze point of the user 110 stays for a preset time period or longer as a gaze area including the gaze point. The preset time period may be set when manufacturing the refrigerator 100, or may be set by the user 110. When receiving the control signal for opening the door from the processor 210, the motor driver 220 may vary the opening speed of the door. For example, when the opening of the first door 102 is detected by a door switch included in the first motor driver 221, the motor driver 220 rotates the motor 225 at a high speed for a certain time period or up to a certain angle. After rotating the motor 225 at high speed for the certain time period or up to the certain angle, the motor driver 220 may reduce the number of rotations of the first motor 225 to rotate the first motor 225 at a lower speed. When the first motor 225 rotates at a high speed, it indicates that the opening speed of the first door 102 is fast, and when the first motor 225 rotates at a low speed, it indicates that the opening speed of the first door 102 is slow. The above-described operational relationship among the first door 102, the first motor driver 221, and the first motor 225 is applied to operational relationship among the second to fourth doors 103 to 105, the second to fourth motor drivers 222 to 224, and the second to fourth motors 226 to 228.

When a preset time period has elapsed since opening of the door, the processor 210 may transmit a control signal for closing the opened door to the door driving unit 220. For example, when the opened door is the first door 102, the control signal transmitted from the processor 210 to the door driving unit 220 may represent a control signal for activating operations of the first motor driver 221 and the first motor 225 and deactivating operations of the second to fourth motor drivers 222 to 224 and the second to fourth motors 226 to 228. When the opened door is the second door 103, the control signal transmitted from the processor 210 to the door driving unit 220 may represent a control signal for activating operations of the second motor driver 222 and the second motor 226 and deactivating operations of the first, third, and fourth motor drivers 221, 223, and 224 and the first, third, and fourth motors 225, 227, and 228. When the opened door is the third door 104, the control signal transmitted from the processor 210 to the door driving unit 220 may represent a control signal for activating operations of the third motor driver 223 and the third motor 227 and deactivating operations of the first, second, and fourth motor drivers 221, 222, and 224 and the first, second, and fourth motors 225, 226, and 228. When the opened door is the fourth door 105, the control signal transmitted from the processor 210 to the door driving unit 220 may represent a control signal for activating operations of the fourth motor driver 224 and the fourth motor 228 and deactivating operations of the first to third motor drivers 221 to 223 and the first to third motors 225 to 227. Transmitting, by the processor 210, a control signal for closing the opened door to the door driving unit 220 may indicate that the door driving unit 220 is controlled by the processor 201 to close the opened door.

The door driving unit 220 may control a rotation speed of a motor differently depending on an angle at which a door is opened. For example, in a state in which the first door 102 is open at 90 degrees and moved to 30 degrees, the first motor 225 may be driven at a low speed to close the first door 102, and in a state in which the first door 102 is opened to within 30 degrees, a driving speed of the first motor 225 may be controlled to be high. The above-described operational relationship among the first door 102, the first motor driver 221, and the first motor 225 is applied to operational relationship among the second to fourth doors 103 to 105, the second to fourth motor drivers 222 to 224, and the second to fourth motors 226 to 228.

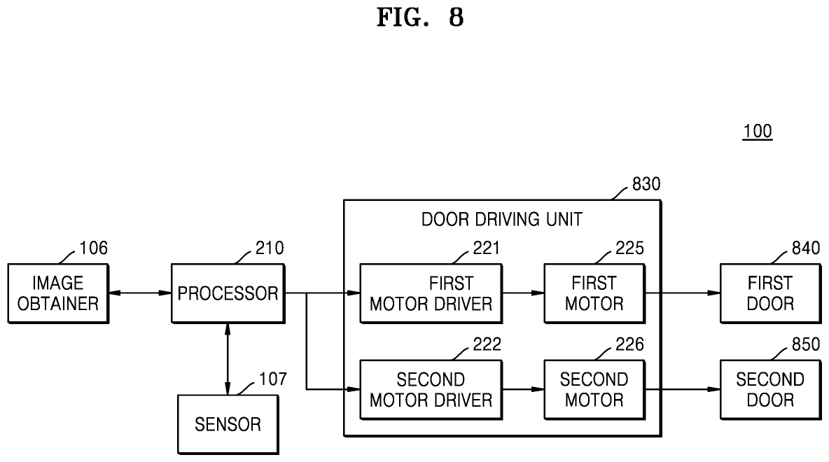

FIG. 8 is a block diagram illustrating functions of a refrigerator 100 according to an embodiment of the present disclosure. FIG. 8 is an example in which when the refrigerator 100 uses a sensor 107 to determine that the user 110 is approaching the refrigerator 100, the refrigerator 100 activates an image obtainer 106 to track a gaze of the user 110, determines a door that the user 110 desires to open based on the tracked gaze of the user 110, and opens the determined door, and thereafter, when the user 110 moves away from the refrigerator 100 by a certain distance or more, the refrigerator 100 closes the opened door.

Referring to FIG. 8, the refrigerator 100 includes the image obtainer 106, the sensor 107, a processor 820, a door driving unit 830, and first and second doors 840 and 850, but the configuration of the refrigerator 100 is not limited to that shown in FIG. 8.

The sensor 107 measures a distance value between a current location of the user 110 and the refrigerator 100 and transmits the measured distance value to the processor 820. To achieve this, the sensor 107 may include, but is not limited to, an ultrasonic sensor, a radio frequency (RF) sensor (radio detection and ranging (RADAR)), an infrared sensor, or a proximity sensor. The sensor 107 serves to detect the user 110 approaching the refrigerator 100 and may be referred to as a proximity sensor.

FIG. 9 is an exemplary diagram of the refrigerator 100 equipped with the image obtainer 106 and the sensor 107 of FIG. 8. The refrigerator 100 of FIG. 9 includes two doors and may include three gaze areas 911, 912, and 913 at a mid-height. Referring to FIG. 9, when the user 110 is recognized by the sensor 107 (for example, when the user 110 approaches the refrigerator 100 within a predetermined distance), the processor 820 activates the image obtainer 106 to obtain image data of the user 110. The processor 820 analyzes a gaze direction of the user 110 by using the obtained image data of the user 110. When detecting a gaze area in which a gaze point of the user 110 stays for a preset time period or longer from among the three gaze areas 911, 912, and 913, the processor 820 determines a door corresponding to the detected gaze area as a door to be opened. The sensor 107 may be further arranged at a first location 901 and a second location 902 shown in FIG. 9. As shown in FIG. 9, each of the gaze areas 911, 912, and 913 may be defined as a partial region of the front of the refrigerator 100 or a partial region of a front surface of the door.

The processor 820 may determine the door to be opened, as shown in Table 900 of FIG. 9. For example, when it is determined that the gaze point of the user 110 stays in area 1 that is the gaze area 911 among the three gaze areas 911, 912, and 913 for a preset time period or longer, the processor 820 transmits a control signal for opening the first door 840 to the door driving unit 830. For example, when it is determined that the gaze point of the user 110 stays in area 2 that is the gaze area 912 among the three gaze areas 911, 912, and 913 for a preset time period or longer, the processor 820 transmits a control signal for opening the second door 850 to the door driving unit 830. For example, when it is determined that the gaze point of the user 110 stays on the gaze area 913 that is a central area of the area 1 911 and the area 2 912 for a preset time period or longer, the processor 820 transmits a control signal for simultaneously opening the first door 840 and the second door 850 to the door driving unit 830. The first door 840 may be expressed as a left door of the refrigerator 100. The second door 850 may be expressed as a right door of the refrigerator 100. Additionally, the central area 913 may be expressed as a boundary area between the first door 840 and the second door 850.

According to an embodiment of the present disclosure, when it is determined that the gaze point of the user 110 stays in the area 1 911 for the preset time period or longer and then stays in the area 2 912 for the preset time period or longer, the processor 820 may transmit a control signal for sequentially opening the first door 840 and the second door 850 to the door driving unit 830. In this case, after the first door 840 is opened, the second door 850 may also be opened sequentially. When the second door 850 is also opened sequentially after the first door 840 is opened, the second door 850 is an unopened door and may be defined as a door other than the first door 840, and the area 2 912 may be defined as a gaze point different from that for the area 1 911.

An operation in which the processor 820 tracks a gaze of the user 110 based on the image data of the user 110 received from the image obtainer 106 may be performed in the same manner as the operation of the processor 210 described with reference to FIG. 2. A control signal transmitted from the processor 820 to the door driving unit 830 depending on which door is determined to be opened may be transmitted in the same manner as the control signal transmitted from the processor 210 to the door driving unit 220 as described with reference to FIG. 2. The transmission of a control signal from the processor 820 to the door driving unit 220 may indicate that the door driving unit 220 is controlled by the processor 820.

When opening or closing a door, the processor 820 may use an output value of the sensor 107 to prevent the user 110 from colliding with the door. For example, when it is determined, based on the output value of the sensor 107, that a first distance value between the user 110 and the refrigerator 100 is greater than or equal to a first threshold value (e.g., 30 cm) and less than a second threshold value (e.g., 60 cm), the processor 820 may transmit a control signal for opening the determined door to the door driving unit 830. After opening the determined door, when it is determined, based on the output value of the sensor 107, that a second distance value between the refrigerator 100 and the user 110 is greater than or equal to the second threshold value, the processor 820 may transmit a control signal for closing the opened door to the door driving unit 830. When a certain time period has elapsed since the opening of the determined door, the processor 820 may activate an operation of the sensor 107 to detect the second distance value between the refrigerator 100 and the user 110. The first distance value represents a distance value between the refrigerator 100 and the user 110 before the door is opened, and the second distance value represents a distance value between the refrigerator 100 and the user 110 after the door is opened.

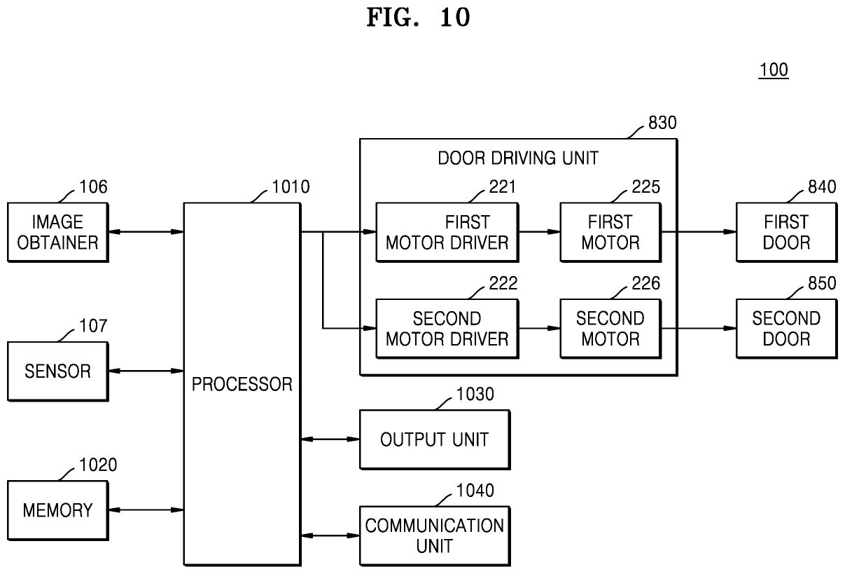

According to an embodiment of the present disclosure, when the distance value between the user 110 and the refrigerator 100 is determined to be less than the first threshold value (e.g., 30 cm) based on the output value of the sensor 107, the processor 820 may not transmit a control signal for opening the door to the door driving unit 830 because the user 110 and the door may collide due to the opening of the door. When the processor 820 does not transmit a control signal to the door driving unit 830 to open the door, this indicates that the processor 820 does not control the door driving unit 830 to open the door. In addition, when the distance value between the user 110 and the refrigerator 100 is less than the first threshold value (e.g., 30 cm), the processor 820 may output a message guiding the user 110 to move away from the refrigerator 100 by the first distance value or more. In this case, the message may be output via the output unit 1030 shown in FIG. 10.

After opening the determined door, when the second distance value between the refrigerator 100 and the user 110 is less than the second threshold value, the processor 820 may not transmit a control signal for closing the opened door to the door driving unit 830 until the second distance value between the refrigerator 100 and the user 110 is the second threshold value or higher. This means that the processor 820 does not control the door driving unit 830 to close the opened door.

The processor 820 may activate the operation of the image obtainer 106 when the first distance value detected using a sensing value (or output value) received from the sensor 107 is determined to be less than the second threshold value in a state in which the determined door is closed. Additionally, the processor 820 may deactivate the operation of the image obtainer 106 when the output value of the sensor 107 is the second threshold value or higher after opening and closing the determined door. In this way, the processor 820 may efficiently manage the resources of the refrigerator 100 by activating the operation of the image obtainer 106 when the user 110 approaches the refrigerator 100 within a threshold distance, and deactivating the operation of the image obtainer 106 when the user 110 moves away from the refrigerator 100 by the threshold distance or higher.

FIG. 10 is a block diagram illustrating functions of a refrigerator 100 according to an embodiment of the present disclosure. The refrigerator 100 shown in FIG. 10 includes the image obtainer 106, the sensor 107, a processor 1010, the memory 1020, the output unit 1030, a communication unit 1040, the door driving unit 830, the first door 840, and the second door 850. The memory 1020, the output unit 1030, and the communication unit 1040 shown in FIG. 10 may be added to the refrigerator 100 shown in FIGS. 2 and 8.

The memory 1020 may store 2D plane coordinate values of the refrigerator 100, programs such as an eye tracking program or an eye tracking application for the user 110, and programs and data for performing operations of the processor 1010.

The memory 1020 may include non-volatile semiconductor memory devices or non-volatile memory devices, such as read-only memory (ROM), high-speed random access memory (RAM), magnetic disk storage devices, and flash memory devices. For example, the memory 1020 may include, as semiconductor memory devices, a Secure Digital (SD) memory card, an SD High Capacity (SDHC) memory card, a mini SD memory card, a mini SDHC memory card, a Trans-Flash (TF) memory card, a micro SD memory card, a micro SDHC memory card, a memory stick, a Compact Flash (CF) memory card, a Multi-Media Card (MMC), MMC micro, an extreme Digital (XD) card, etc. The memory 1020 may be referred to as a storage. In addition, the memory 1020 may include a network-attached storage device accessed via a network.

The output unit 1030 includes a display and/or an audio output unit, and may output guidance information necessary to open or close a door of the refrigerator 100. FIG. 11 is an example of providing guidance information regarding a door to be opened (e.g., the first door 840) via the output unit 1030 included in the refrigerator 100, according to an embodiment of the present disclosure. Referring to FIG. 11, this is an example in which the output unit 1030 is a display, and the display displays an image 1110 corresponding to the refrigerator 100 and guidance information 1120 regarding the first door 840 to be opened among doors of the refrigerator 100. Accordingly, the output unit 1030 may be referred to as the display. The guidance information 1120 may be provided as marking information indicating the first door 840 to be opened, e.g., in the form of a highlight, provided together with a voice message, or provided as a voice message only.

Additionally, the output unit 1030 may output a message guiding the user 110 to move away from the refrigerator 100 by the first distance value or more, as described with reference to FIG. 8. The output unit 1030 may include a lighting device, such as a light-emitting diode (LED), located close to the area 1 911 and the area 2 912 shown in FIG. 9. The output unit 1030 may use the lighting device to display information guiding the user 110 about a gaze area where the user 110 can gaze to open at least one door. Displaying, by the output unit 1030, information guiding the user 110 about a gaze area may indicate providing, by the output unit 1030, the information guiding the user 110 about the gaze area. The processor 1010 may control the above-described operations of the output unit 1030.

The communication unit 1040 may communicate with an external device of the refrigerator 100 in a wired or wireless manner. The external device is a device having a communication channel established with the refrigerator 100. The external device may be at least one of a home server, another server connected to the home server, other home appliances in the home, or a mobile terminal of the user 110. The communication unit 1040 may perform data communication according to standards for the home server.

The communication unit 1040 may transmit and receive data related to remote control over a network, and transmit and receive information related to operations of the other home appliances, and the like. Furthermore, the communication unit 1040 may receive information about a life pattern of the user 110 from a server and utilize it for the operation of the refrigerator 100. Additionally, the communication unit 1040 may perform data communication with the mobile terminal of the user 110 as well as with the home server or remote control in the home.

The communication unit 1040 may include, for example, a short-range communication module, a wired communication module, and a mobile communication module.

The short-range communication module may be a module for short-range communication within a predetermined distance. Short-distance communication technologies may include, but are not limited to, wireless LAN, Wi-Fi, Bluetooth, ZigBee, Wi-Fi Direct (WFD), ultra-wideband (UWB), infrared Data Association (IrDA), Bluetooth Low Energy (BLE), and near field communication (NFC).

The wired communication module refers to a module for communication using electrical signals or optical signals. Wired communication technologies may include pair cables, coaxial cables, optical fiber cables, and Ethernet cables, but are not limited thereto.

The mobile communication module may transmit and receive wireless signals to and from at least one of a base station, an external terminal, and a server on a mobile communication network. The wireless signals may include voice call signals, video call signals, or various forms of data according to transmission and reception of text/multimedia messages.

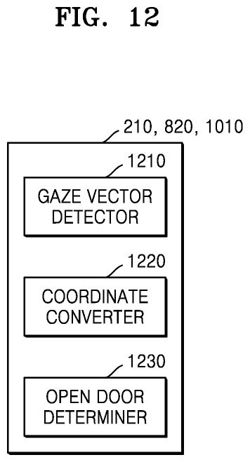

FIG. 12 is a block diagram illustrating functions of the processors 210, 820, and 1010 included in the refrigerator 100, according to an embodiment of the present disclosure. Each of the processors 210, 820, and 1010 included in the refrigerator 100 may process or control all operations of the refrigerator 100, and as shown in FIG. 12, and include, but is not limited to, a gaze vector detector 1210, a coordinate converter 1220, and an open door determiner 1230.

The gaze vector detector 1210 detects a gaze vector of the user 110 based on image data of the user obtained by the image obtainer 106, as described with reference to FIG. 2. The coordinate converter 1220 converts coordinate information based on the detected gaze vector of the user 110 into 2D plane coordinate information of the front of the refrigerator 100, as described with reference to FIG. 2. The open door determiner 1230 determines a door corresponding to a gaze area that includes the 2D plane coordinate information of the front of the refrigerator 100 corresponding to the coordinate information based on the gaze vector of the user 110.

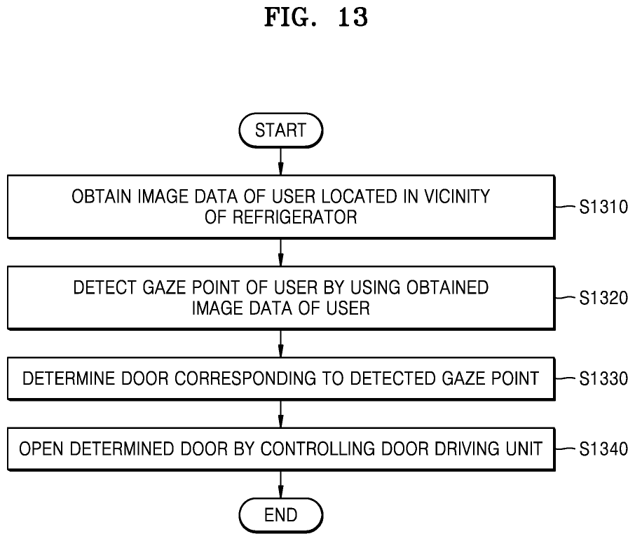

FIG. 13 is a flowchart illustrating a control method of a refrigerator, according to an embodiment of the present disclosure.

In operation S1310, the refrigerator 100 obtains image data of the user 110 located in a vicinity of the refrigerator 100 by using the image obtainer 106. The refrigerator 100 may include at least one door as described with reference to FIG. 1. As described with reference to FIG. 2, the refrigerator 100 may obtain image data of the user 110 located in a vicinity of the refrigerator 100 or a door of the refrigerator 100 by using the image obtainer 106. The image data of the user 110 may include an image of an eyeball of the user 110. The image data of the user 110 may be infrared image data, color image data, or black-and-white image data, but is not limited thereto.

According to an embodiment of the present disclosure, the refrigerator 100 may activate an operation of the image obtainer 106 when a distance value (or an output value of the sensor 107) between the user 110 and the refrigerator 100, which is measured by the sensor 107, is less than a second threshold value (e.g., 60 cm) in a state in which the door is closed. In this case, the image obtainer 106 may remain deactivated and be activated when the user 110 approaches the vicinity of the refrigerator 100 to obtain an image of an eyeball in order to track a gaze of the user 110.

In operation S1320, the refrigerator 100 detects a gaze point of the user 110 by using the obtained image data of the user 110, as described with reference to FIG. 2. For example, the refrigerator 100 may detect a shape of an eyeball, as described with reference to FIG. 5. The refrigerator 100 may detect the center 514 of the iris 513 and the glint 516 of light reflected off the cornea, which are included in the detected eyeball shape. The refrigerator 100 may detect a gaze vector of the user 110 by using the vector value 517 between the center 514 of the iris 513 and the glint 516 of light. When the gaze vector of the user 110 is detected, the refrigerator 100 may detect 2D plane coordinate values of the front of the refrigerator 100 based on the detected gaze vector. The refrigerator 100 may define the 2D plane coordinate values of the front of the refrigerator 100 as the gaze point of the user 110.

In operation S1330, the refrigerator 100 determines a door corresponding to the detected gaze point of the user 110. For example, as shown in FIG. 9, when the gaze point of the user 110 is the area 1 911, the refrigerator 100 may determine the first door 840 as a door to be opened. As shown in FIG. 9, when the gaze point of the user 110 is the area 2 912, the refrigerator 100 may determine the second door 850 as the door to be opened. As shown in FIG. 9, when the gaze point of the user 110 is the central area 932, the refrigerator 100 may determine the first door 840 and the second door 850 as the doors to be opened.

In operation S1340, the refrigerator 100 controls the door driving unit 220 or 830 to open the determined door. To control the door driving unit 220 or 830, a control signal is transmitted from the processor 210, 820, or 1010 of the refrigerator 100 to the door driving unit 220 or 830, as described with reference to FIG. 2 or 8. For example, when the determined door is the first door 840, the processor 820 or 1010 of the refrigerator 100 may transmit a control signal for opening the first door 840 to the door driving unit 830. When the determined door is the second door 850, the processor 820 or 1010 of the refrigerator 100 may transmit a control signal for opening the second door 850 to the door driving unit 830. When the determined doors are the first door 840 and the second door 850, the processor 820 or 1010 of the refrigerator 100 may transmit a control signal for opening both the first door 840 and the second door 850 to the door driving unit 830. The transmission of a control signal from the processor 820 or 1010 to the door driving unit 830 indicates that the door driving unit 830 is controlled by the processor 820 or 1010.

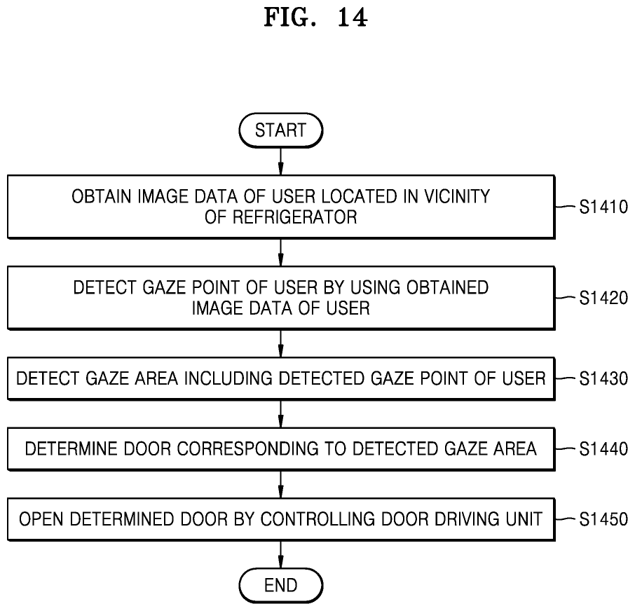

FIG. 14 is a flowchart illustrating a control method of a refrigerator, according to an embodiment of the present disclosure.

In operation S1410, the refrigerator 100 obtains image data of the user 110 located in a vicinity of the refrigerator 100 by using the image obtainer 106. The refrigerator 100 may include at least one door as described with reference to FIG. 1. As described with reference to FIG. 2, the refrigerator 100 may obtain image data of the user 110 located in a vicinity of the refrigerator 100 by using the image obtainer 106. The image data of the user 110 may include an image of an eyeball of the user 110. The image data of the user 110 may be infrared image data, color image data, or black-and-white image data, but is not limited thereto.

According to an embodiment of the present disclosure, the refrigerator 100 may activate an operation of the image obtainer 106 when a distance value (or an output value of the sensor 107) between the user 110 and the refrigerator 100, which is measured by the sensor 107, is less than the second threshold value (e.g., 60 cm) in a state in which the door is closed. In this case, the image obtainer 106 may remain deactivated and be activated when the user 110 approaches the vicinity of the refrigerator 100 to obtain an image of an eyeball in order to track a gaze of the user 110.

In operation S1420, the refrigerator 100 detects a gaze point of the user 110 by using the obtained image data of the user 110, as described with reference to FIG. 2. For example, the refrigerator 100 may detect a shape of an eyeball of the user 110, as described with reference to FIG. 5. The refrigerator 100 may detect the center 514 of the iris 513 and the glint 516 of light reflected off the cornea, which are included in the detected shape of the eyeball. The refrigerator 100 may detect a gaze vector of the user 110 by using the vector value 517 between the center 514 of the iris 513 and the glint 516 of light. When the gaze vector of the user 110 is detected, the refrigerator 100 may detect 2D plane coordinate values of the front of the refrigerator 100 based on the detected gaze vector. The refrigerator 100 may define the 2D plane coordinate values of the front of the refrigerator 100 as the gaze point of the user 110.

In operation S1430, the refrigerator 100 detects a gaze area of the refrigerator 100, which includes the detected gaze point of the user 110, as described with reference to FIG. 2. The gaze area may be an area where the user 110 gazes (or the user's gaze stays) at the front of the refrigerator 100 for a preset time period or longer in order to open at least one door. The gaze area may be an area associated with one door, or may be an area associated with a plurality of doors (e.g., a boundary area between doors). For example, the gaze area may be a specific point on the front of the refrigerator 100. The specific point may include, for example, at least one of the area 1 911, the area 2 912, and the central area 913 shown in FIG. 9.

The gaze area according to the present disclosure may be a virtual area obtained by arbitrarily dividing the front of the refrigerator 100. The gaze area may be a single gaze area or a plurality of gaze areas. The gaze area may be an area obtained by dividing the entire front of the refrigerator 100, or dividing a partial region of the front of the refrigerator 100 (for example, a mid-height region). As shown in FIG. 6, the gaze area may be obtained by dividing the front of the refrigerator 100 into six areas when the refrigerator 100 has four doors. Additionally, when the refrigerator 100 includes a display-based output unit 1030, the refrigerator 100 may define an area of the front of the refrigerator 100, excluding an area where the output unit 1030 is disposed, as the gaze area. The user 110 may frequently gaze at the output unit 1030 to check information displayed on the display-based output unit 1030, and in this case, the user 110 may not be gazing at the output unit 1030 to open a door including the output unit 1030. Therefore, by excluding, from a gaze area for the refrigerator 100, a front area of the door where the display-based output unit 1030 may be disposed, a door where the output unit 1030 is disposed may be prevented from automatically opening against the will of the user 110 when the user 110 gazes at the output unit 1030 to check information displayed on the display-based output unit 1030.

In operation S1440, the refrigerator 100 determines a door corresponding to the detected gaze area as described with reference to FIG. 2. For example, when the gaze area for the refrigerator 100 is divided into the first to sixth gaze areas 601 to 606, and the gaze point of the user 110 is the point 607, as shown in FIG. 6, the refrigerator 100 may determine the first gaze area 601 including the gaze point 607 as the gaze area, and determine the first door 102 corresponding to the first gaze area 601 as the door to be opened.

In operation S1450, the refrigerator 100 controls the door driving unit 220 to open the determined door. To this end, the processor 210 of the refrigerator 100 transmits a control signal to the door driving unit 220. The control signal transmitted to the door driving unit 220 is as described with reference to FIG. 2. For example, when determining the first door 102 as the door to be opened, the processor 210 of the refrigerator 100 transmits a control signal for opening the first door 102 to the door driving unit 220. When determining the second door 103 as the door to be opened, the processor 210 of the refrigerator 100 transmits a control signal for opening the second door 103 to the door driving unit 220. When determining the third door 104 as the door to be opened, the processor 210 of the refrigerator 100 transmits a control signal for opening the third door 104 to the door driving unit 220. When determining the fourth door 105 as the door to be opened, the processor 210 of the refrigerator 100 transmits a control signal for opening the fourth door 105 to the door driving unit 220. The transmission of a control signal from the processor 210 to the door driving unit 220 indicates that the processor 210 controls the door driving unit 220.

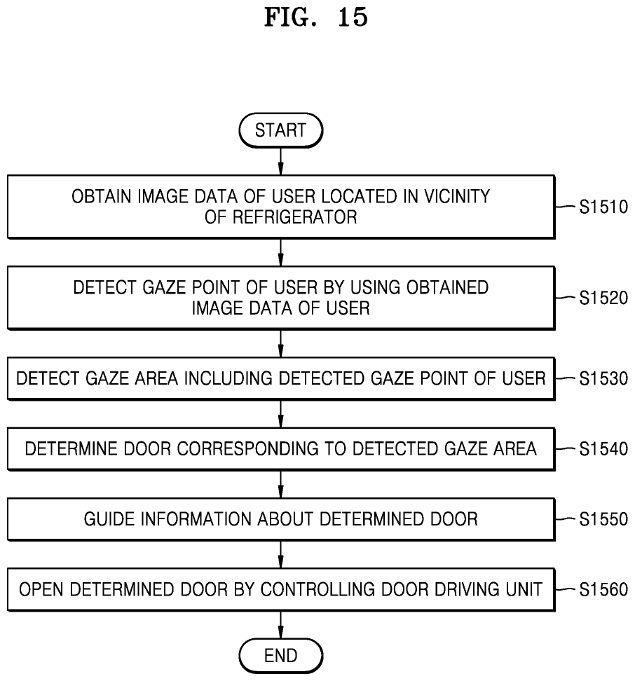

FIG. 15 is a flowchart illustrating a control method of a refrigerator, according to an embodiment of the present disclosure. FIG. 15 is an example of adding a function of guiding information about the door determined in the flowchart of FIG. 14.

In operation S1510 of FIG. 15, the refrigerator 100 may obtain image data of the user 110. In operation S1520, the refrigerator 100 may detect a gaze point of the user 110 by using the obtained image data of the user 110. In operation S1530, the refrigerator 100 may detect a gaze area including the detected gaze point of the user 110. In operation S1540, the refrigerator 100 may determine a door corresponding to the detected gaze area. Because operations S1510 to S1540 and S1560 of FIG. 15 respectively correspond to operations S1410 to S1450 of FIG. 14, detailed descriptions thereof will be omitted here.

In operation S1550, the refrigerator 100 guides information about the determined door. For example, the refrigerator 100 may guide information about the determined door via a display included in the output unit 1030, as shown in FIG. 11. In this case, the display-based output unit 1030 may be excluded from the gaze point of the user 110. In addition, the refrigerator 100 may guide information about the determined door via a speaker included in the output unit 1030. For example, the refrigerator 100 may output a voice guidance message such as ‘The door on the upper right will be opening soon.’ Accordingly, the user 110 may check whether the door to be opened or closed is correctly selected according to the intention of the user 110.

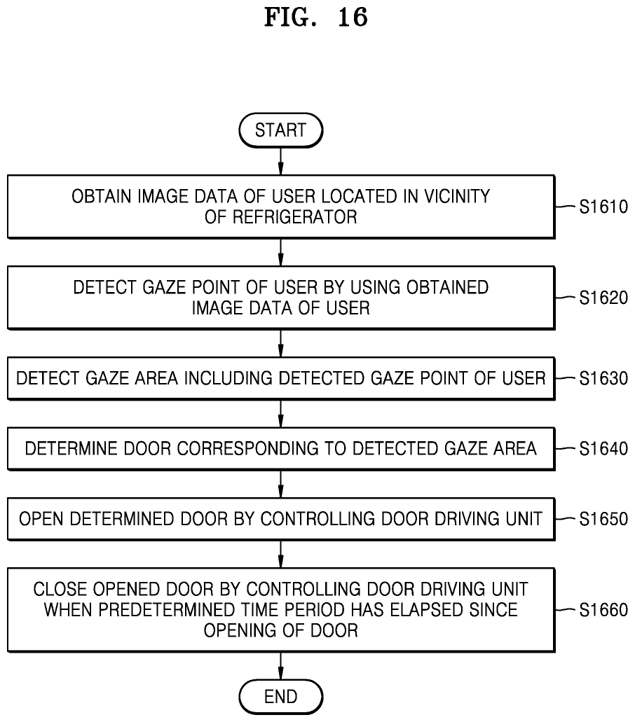

FIG. 16 is a flowchart illustrating a control method of a refrigerator, according to an embodiment of the present disclosure. FIG. 15 is an example of adding a function of closing the opened door to the flowchart of FIG. 14.

In operation S1610, the refrigerator 100 may obtain image data of the user 110. In operation S1620, the refrigerator 100 may detect a gaze point of the user 110 by using the obtained image data of the user 110. In operation S1630, the refrigerator 100 may detect a gaze area including the detected gaze point of the user 110. In operation S1640, the refrigerator 100 may determine a door corresponding to the detected gaze area. In operation S1650, the refrigerator 100 may transmit a control signal for opening the determined door to the door driving unit 220 or 830. Because operations S1610 to S1650 of FIG. 16 respectively correspond to operations S1410 to S1450 of FIG. 14, detailed descriptions thereof will be omitted here.

In operation S1650, when a certain time period has elapsed since opening of the door, the refrigerator 100 controls the door driving unit 220 or 830 to close the opened door. To this end, the processor 210, 820, or 1010 transmits a control signal for closing the opened door to the door driving unit 220 or 830. The certain time period may be sufficient time for the user 110 to place objects (e.g., food, ingredients, containers, etc.) into or out of the refrigerator 100. The certain time period may be a time preset at the factory for the refrigerator 100, or a time set by the user 110. The user 110 may change the certain time period by using the display included in the output unit 1030 of the refrigerator 100 or an application on a mobile terminal.

Moreover, according to an embodiment of the present disclosure, when the user 110 is detected by the sensor 107 (e.g., a proximity sensor) even after the certain time period has elapsed, the refrigerator 100 may not transmit a control signal for closing the door to the door driving unit 220 or 830 in order to prevent the user 110 from colliding with the door. Not transmitting the control signal for closing the door to the door driving unit 220 or 830 indicates that the processors 210, 820, or 1010 of the refrigerator 100 does not control the door driving unit 220 or 830 to close the door.

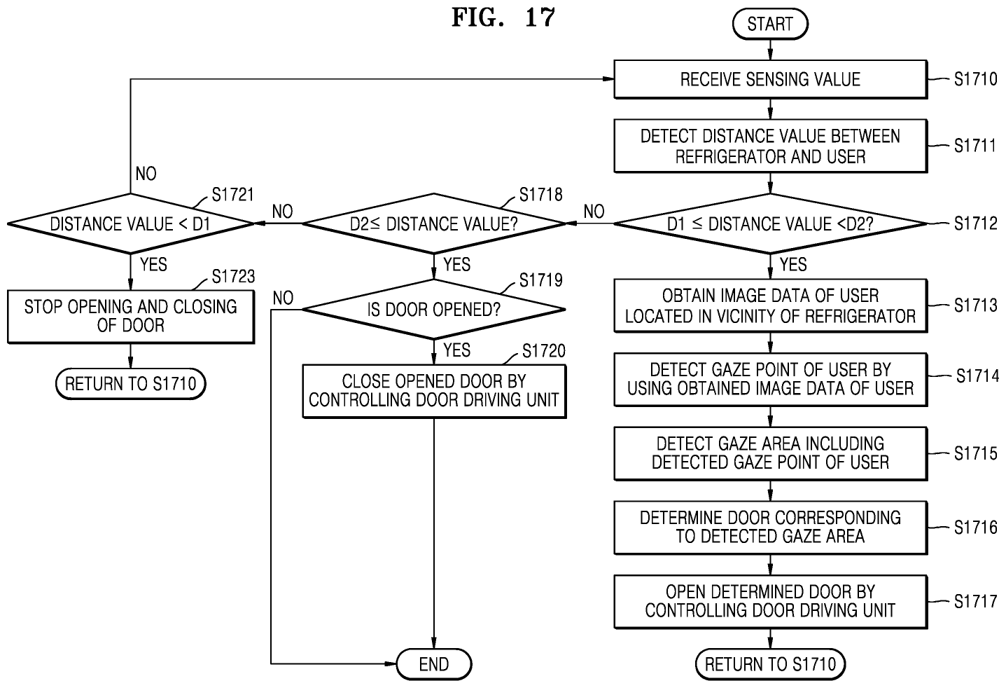

FIG. 17 is a flowchart illustrating a control method of a refrigerator, according to an embodiment of the present disclosure. FIG. 17 is an example of adding, to the flowchart of FIG. 14, a function of controlling a door opening/closing function based on a distance value between the refrigerator 100 and the user 110.

In operation S1710, the refrigerator 100 receives a sensing value (or an output value) from the sensor 107. In operation S1711, the refrigerator 100 detects a distance value between the refrigerator 100 and the user 110 based on the received sensing value.

In operation S1712, when the detected distance value is determined to be greater than or equal to a first threshold value d1 and less than a second threshold value d2, in operation S1713, the refrigerator 100 may obtain image data of the user 110 located in a vicinity of the refrigerator 100 or a door of the refrigerator 100. In this case, the detected distance value in operation S1712 may be defined as a first distance value because it is before a door is opened or closed.

In operation S1714, the refrigerator 100 may detect a gaze point of the user 110 by using the obtained image data of the user 110. In operation S1715, the refrigerator 100 may detect a gaze area including the detected gaze point of the user 110. In operation S1716, the refrigerator 100 may determine a door corresponding to the detected gaze area. In operation S1717, the refrigerator 100 controls the door driving unit 220 or 830 to open the determined door. To achieve, the processor 210, 820, or 1010 may transmit a control signal to the door driving unit 220 or 830. Because operations S1714 to S1717 respectively correspond to operations S1420 to S1450 of FIG. 14, detailed descriptions thereof will be omitted here.

After transmitting the control signal for opening the determined door to the door driving unit 220 or 830, the refrigerator 100 returns to operation S1710 to determine a relationship between the distance value between the refrigerator 100 and the user 110 and the first threshold value d1 and the second threshold value d2 based on a sensing value (or output value) received from the sensor 107. In this case, the distance value may be defined as a second distance value because it is after the door is opened. In operations S1718 and S1719, when the refrigerator 100 determines that the distance value (second distance value) between the refrigerator 100 and the user 110 is greater than or equal to the second threshold value d2 and that the door of the refrigerator 100 is opened, in operation S1720, the refrigerator 100 controls the door driving unit 220 or 830 to close the opened door and ends a door opening and closing operation. The processor 210, 820, or 1010 of the refrigerator 100 controls the door driving unit 220 or 830 to close the opened door. In order to control the door driving unit 220 or 830 to close the opened door, the processor 210, 820, or 1010 transmits a control signal for closing the opened door to the door driving unit 220 or 830.

In operation S1718, when the second distance value between the refrigerator 100 and the user 110 is determined not to be greater than or equal to the second threshold value d2, in operation S1721, the refrigerator 100 determines whether the distance value (second distance value) between the refrigerator 100 and the user 110 is less than the first threshold value d1. In operation S1721, when the distance value (second distance value) between the refrigerator 100 and the user 110 is determined to be less than the first threshold value d1, in operation S1723, the refrigerator 100 stops the door opening and closing operation and returns to operation S1710. By doing so, a collision between the door of the refrigerator 100 and the user 110, due to the door opening and closing operation, may be prevented.

In operation S1721, when the distance value (second distance value) between the refrigerator 100 and the user 110 is determined not to be less than the first threshold value d1, the refrigerator 100 returns to operation S1710 and monitors a sensing value (or output value) received from the sensor 107.

The distance value between the refrigerator 100 and the user 110 described with reference to FIG. 17 may be defined as the first distance value before the determined door is opened, and the second distance value after the determined door is opened.

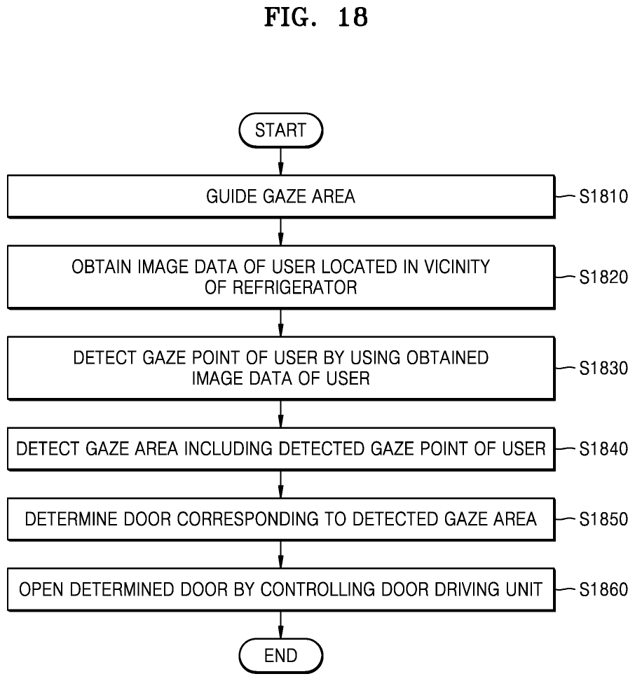

The flowchart of FIG. 17 may be modified to add a function of guiding information about the determined door described in operation S1550 of FIG. 15 after the door to be opened is determined but before the determined door is opened. The flowchart of FIG. 17 may be modified to add a function of guiding a gaze area described in operation S1810 of FIG. 18 below before detecting the gaze area including the gaze point and determining the door to be opened.

FIG. 18 is a flowchart illustrating a control method of a refrigerator, according to an embodiment of the present disclosure. FIG. 18 is an example of adding a function of guiding a gaze area of the user 110 to the flowchart of FIG. 14.

In operation S1810, the refrigerator 100 may guide a gaze area where the user 110 may gaze to open a door by using the output unit 1030. For example, an LED light device may be located close to the area 1 911 and the area 2 912 shown in FIG. 9 to guide the user 110 to the gaze area. The output unit 1030 may include a lighting device controlled by the processor 1010 to emit light continuously outward from the refrigerator 100 or at regular time intervals.

In operation S1820, the refrigerator 100 may obtain image data of the user 110 located in a vicinity of the refrigerator 100 or a door of the refrigerator 100. In operation S1830, the refrigerator 100 may detect a gaze point of the user 110 by using the obtained image data of the user 110. In operation S1840, the refrigerator 100 may detect a gaze area including the detected gaze point of the user 110. In operation S1850, the refrigerator 100 may determine a door corresponding to the detected gaze area. In operation S1860, the refrigerator 100 may control the door driving unit 220 or 830 to open the determined door. To control the door driving unit 220 or 830 to open the determined door, the processor 210, 820, or 1010 of the refrigerator 100 may transmit a control signal to the door driving unit 220 or 830. Because operations S1820 to S1860 of FIG. 18 respectively correspond to operations S1410 to S1450 of FIG. 14, detailed descriptions thereof will be omitted here.

In addition, each of the flowcharts illustrated in FIGS. 14 to 18 may be modified to further include, before performing an operation based on the flowchart, an operation of setting at least one gaze area including a gaze point of the user 110 based on the number of doors of the refrigerator 100 or the structure of the refrigerator 100. For example, each of the flowcharts illustrated in FIGS. 14 to 18 may further include, when the refrigerator 100 has four doors, an operation of dividing a gaze area for the refrigerator 100 into six gaze areas as shown in FIG. 6, or when the refrigerator 100 has two doors, an operation of setting the three specific points 911, 912, and 913 as gaze areas as shown in FIG. 9.

Although each of the flowcharts of FIGS. 13 to 18 illustrates a case of obtaining image data of the user 110 located in the vicinity of the refrigerator 100 by using the image obtainer 106, each of the flowcharts of FIGS. 13 to 18 may further include a function of obtaining the image data of the user 110 located in the vicinity of the refrigerator 100 or a door of the refrigerator 100 by activating the image obtainer 106 when a distance value between the refrigerator 100 and the user 110 is determined to be less than the second threshold value d2. In addition, each of the flowcharts of FIGS. 13 to 18 may further include, after the door of the refrigerator 100 performs the opening and closing operation, an operation of deactivating an operation of the image obtainer 106 when the distance value between the user 110 and the refrigerator 100 is determined to be greater than or equal to the second threshold value based on a sensing value (or an output value) of the sensor 107. After the door of the refrigerator 100 performs the opening and closing operation, when the distance value between the user 110 and the refrigerator 100 is determined to be greater than or equal to the second threshold value based on the sensing value (or output value) of the sensor 107, this may indicate that a location of the user 110 is farther away from the refrigerator 100.

Although each of the flowcharts of FIGS. 13 to 18 illustrates a case of opening and closing one door of the refrigerator 100, after opening the determined door and before closing it, when another gaze point is detected by using the image data of the user 110 obtained via the image obtainer 106, the flowchart may further include a function of determining a door corresponding to the detected other gaze point among the unopened doors of the refrigerator 100 and controlling the determined door to be opened. For example, when a point included in the third gaze area 603 corresponding to the second door 103 is detected as a gaze point at which the user 110 gazes while the first door 102 shown in FIG. 6 is opened, each of the flowcharts of FIGS. 13 to 18 may further include a function for allowing the refrigerator 100 to further open the second door 103.

According to an embodiment of the present disclosure, the refrigerator 100 may automatically open a door of the refrigerator 100 as desired by the user 110, based on eye tracking for the user 110, thereby improving convenience for the user 110 when opening and closing the door of the refrigerator 100.

According to an embodiment of the present disclosure, the refrigerator 100 may open and close a door as desired by the user 110 at a more precise time, based on eye tracking for the user 110 and a location of the user 110, thereby preventing incorrect opening and closing of the door of the refrigerator 100 and preventing a collision between the door of the refrigerator 100 and the user 110.

According to an embodiment of the present disclosure, the refrigerator 100 may guide an area where the user 110 can gaze to open the at least one door 102, 103, 104, 105, 840, or 850, thereby allowing the user 110 to more accurately determine a door to be opened.

The refrigerator 100 according to an embodiment of the present disclosure may include the main body 101, the at least one door 102, 103, 104, 105, 840, or 850 rotatably coupled to the front of the main body 101, the door driving unit 220 or 830 for automatically opening and closing the at least one door 102, 103, 104, 105, 840, or 850, the image obtaining sensor 106 for obtaining image data of the user 110 located in a vicinity of the refrigerator 100, and the at least one processor 210, 820, or 1010 configured to detect a gaze point where a gaze of the user 110 stays for a preset time period or longer by using the image data of the user 110, determine a door corresponding to the detected gaze point among the at least one door 102,103,104, 105, 840, or 850, and control the door driving unit 220 or 830 to open the determined door.

According to an embodiment of the present disclosure, the refrigerator 100 may include the proximity sensor 107 that detects the approach of the user 110 to the refrigerator 100, and the at least one processor 210, 820, or 1010 may be configured to, in a state in which the at least one door 102, 103, 104, 105, 840, or 850 is closed, detect a first distance value between the refrigerator 100 and the user 110 by using an output value of the proximity sensor 107, and when the detected first distance value is determined to be greater than or equal to a first threshold value and less than a second threshold value, control the door driving unit 220 or 830 to open the determined door.

According to an embodiment of the present disclosure, the at least one processor 210, 820, or 1010 may be configured to, when the detected first distance value is less than the second threshold value in a state in which the at least one door 102, 103, 104, 105, 840, or 850 is closed, activate an operation of the image obtaining sensor 106 to obtain image data of the user 110 located in a vicinity of the at least one door 102, 103, 104, 105, 840, or 850.

According to an embodiment of the present disclosure, the at least one processor 210, 820, or 1010 may be configured to, after opening the determined door, detect a second distance value between the refrigerator 100 and the user 110 by using an output value of the proximity sensor 107, and when the detected second distance value is greater than or equal to the second threshold value, control the door driving unit 220 or 830 to close the opened door.

According to an embodiment of the present disclosure, the at least one processor 210, 820, or 1010 may be configured to, when a certain time period has elapsed since the opening of the determined door, control the proximity sensor 107 to detect a second distance value between the refrigerator 100 and the user 110.

According to an embodiment of the present disclosure, the at least one processor 210, 820, or 1010 may be configured to deactivate the operation of the image obtaining sensor 106 when the detected second distance value is greater than or equal to the second threshold value after opening and closing the determined door.

According to an embodiment of the present disclosure, the at least one processor 210, 820, or 1010 may be configured to divide the front of the refrigerator 100 into a plurality of virtual gaze areas based on a number of doors of the refrigerator 100 or a structure of the refrigerator 100, and detect an area where a gaze point stays for a preset time period or longer among the plurality of virtual gaze areas as a gaze area of the front of the refrigerator 100 including the gaze point.

According to an embodiment of the present disclosure, the refrigerator 100 may include the output unit 1030 that displays information guiding the user 110 about the plurality of gaze areas where the user 110 can gaze to open the at least one door 102, 103, 104, 105, 840, or 850.

According to an embodiment of the present disclosure, the output unit 1030 may include a lighting device that emits light.

According to an embodiment of the present disclosure, the at least one processor 210, 820, or 1010 may be configured to, when the detected gaze point is a boundary area between the at least one door 102, 103, 104, 105, 840, or 850, control the door driving unit 220 or 830 to open all doors adjacent to the boundary area.

According to an embodiment of the present disclosure, the at least one processor 210, 820, or 1010 may be configured to, after opening the determined door, when another gaze point is detected by using the image data of the user 110 obtained by the image obtaining sensor 106, determine another door corresponding to the detected other gaze point among unopened doors, and control the door driving unit 220 or 830 to open the determined other door.

A control method of the refrigerator 100 according to an embodiment of the present disclosure may include obtaining image data of the user 110 located in a vicinity of the refrigerator 100 by using the image obtaining sensor 106 (S1310, S1410, S1510, S1610, pr S1820), detecting a gaze point where a gaze of the user 110 stays for a preset time period or longer by using the obtained image data of the user 110 (S1320, S1420, S1520, S1620, or S1830), determining a door corresponding to the detected gaze point among at least one door 102, 103, 104, 105, 840, or 850 included in the refrigerator 100 (S1330, S1440, S1540, S1640, or S1850), and opening the determined door by controlling the door driving unit 220 or 830 included in the refrigerator 100 (S1340, S1450, S1560, S1650, or S1860).

According to an embodiment of the present disclosure, the opening of the determined door (S1340, S1450, S1560, S1650, S1860) may include, in a state in which the at least one door 102, 103, 104, 105, 840, or 850 is closed, detecting a first distance value between the refrigerator 100 and the user 110 by using an output value of the proximity sensor 107 included in the refrigerator 100 (S1711), and when the detected first distance value is determined to be greater than or equal to a first threshold value and less than a second threshold value, controlling the door driving unit 220 or 830 to open the determined door (S1717).

According to an embodiment of the present disclosure, the obtaining of the image data of the user 110 (S1310, S1410, S1510, S1610, or S1820) may include, when the detected first distance value is less than the second threshold value in a state in which the at least one door 102, 103, 104, 105, 840, or 850 is closed, obtaining the image data of the user 110 located in the vicinity of the at least one door 102, 103, 104, 105, 840, or 850 by activating an operation of the image obtaining sensor 106.

According to an embodiment of the present disclosure, the control method of the refrigerator may include, after the opening of the determined door, detecting a second distance value between the refrigerator 100 and the user 110 by using an output value of the proximity sensor 107, and when the detected second distance value is greater than or equal to the second threshold value, controlling the door driving unit 220 or 830 to close the opened door (S1720).

According to an embodiment of the present disclosure, the control method of the refrigerator may include deactivating the operation of the image obtaining sensor 106 when the detected second distance value is greater than or equal to the second threshold value after opening and closing the determined door.

According to an embodiment of the present disclosure, the control method of the refrigerator may include dividing the front of the refrigerator 100 into a plurality of virtual gaze areas based on a number of doors of the refrigerator 100 or a structure of the refrigerator 100, and detecting an area where a gaze point stays for a preset time period or longer among the plurality of virtual gaze areas as a gaze area of the front of the refrigerator 100 including the gaze point.

According to an embodiment of the present disclosure, the control method of the refrigerator may include displaying, via the output unit 1030, information for guiding the user 110 about the plurality of gaze areas where the user 110 can gaze to open the at least one door 102, 103, 104, 105, 840, or 850.

According to an embodiment of the present disclosure, the opening of the determined door may include, when the detected gaze point is a boundary area between the at least one door 102, 103, 104, 105, 840, or 850, controlling the door driving unit 220 or 830 to open all doors adjacent to the boundary area.

According to an embodiment of the present disclosure, the control method of the refrigerator 100 may include, after the opening of the determined door, when another gaze point is detected by using the image data of the user 110 obtained by the image obtaining sensor 106, determining another door corresponding to the detected other gaze point among unopened doors, and controlling the door driving unit 220 or 830 to open the determined other door.

A machine-readable storage medium may be provided in the form of a non-transitory storage medium. In this regard, the term ‘non-transitory’ only means that the storage medium does not include a signal (e.g., an electromagnetic wave) and is a tangible device, and the term does not differentiate between where data is semi-permanently stored in the storage medium and where the data is temporarily stored in the storage medium. For example, the ‘non-transitory storage medium’ may include a buffer in which data is temporarily stored.

According to an embodiment, methods according to various embodiments of the disclosure may be included in a computer program product when provided. The computer program product may be traded, as a product, between a seller and a buyer. The computer program product may be distributed in the form of a machine-readable storage medium (e.g., compact disc-ROM (CD-ROM)) or distributed (e.g., downloaded or uploaded) on-line via an application store or directly between two user devices (e.g., smartphones). For online distribution, at least a part of the computer program product (e.g., a downloadable app) may be at least transiently stored or temporally generated in the machine-readable storage medium such as memory of a server of a manufacturer, a server of an application store, or a relay server.

1. A refrigerator comprising:
a main body;
at least one door rotatably coupled to a front of the main body;
a door driving unit configured to automatically open and close the at least one door;
an image obtaining sensor configured to obtain image data of a user located in a vicinity of the refrigerator; and
at least one processor configured to
detect a gaze point where a gaze of the user stays for a preset time period or longer by using the obtained image data of the user,
determine a door corresponding to the detected gaze point among the at least one door, and
control the door driving unit to open the determined door.

2. The refrigerator of claim 1, further comprising:
a proximity sensor configured to detect an approach of the user toward the refrigerator,
wherein the at least one processor is further configured to, in a state in which the at least one door is closed, detect a first distance value between the refrigerator and the user by using an output value of the proximity sensor, and when the detected first distance value is greater than or equal to a first threshold value and less than a second threshold value, control the door driving unit to open the determined door.

3. The refrigerator of claim 2, wherein the at least one processor is further configured to, when the detected first distance value is less than the second threshold value in a state in which the at least one door is closed, activate an operation of the image obtaining sensor to obtain image data of the user located in a vicinity of the at least one door.

4. The refrigerator of claim 3, wherein the at least one processor is further configured to, after opening the determined door, detect a second distance value between the refrigerator and the user by using an output value of the proximity sensor, and when the detected second distance value is greater than or equal to the second threshold value, control the door driving unit to close the opened door.

5. The refrigerator of claim 2, wherein the at least one processor is further configured to, when a certain time period has elapsed since the opening of the determined door, control the proximity sensor to detect a second distance value between the refrigerator and the user.

6. The refrigerator of claim 4, wherein the at least one processor is further configured to deactivate operation of the image obtaining sensor when the detected second distance value is greater than or equal to the second threshold value after opening and closing the determined door.

7. The refrigerator of claim 1, wherein the at least one processor is further configured to
divide a front of the refrigerator into a plurality of virtual gaze areas based on a number of doors of the at least one door or a structure of the refrigerator, and
detect an area where a gaze point stays for a preset time period or longer among the plurality of virtual gaze areas as a gaze area of the front of the refrigerator including the gaze point.

8. The refrigerator of claim 7, further comprising:
an output unit configured to display information to guide the user about virtual gaze areas of the plurality of virtual gaze areas which the user is able to gaze at to open the at least one door.

9. The refrigerator of claim 8, wherein the output unit includes a lighting device configured to emit light.

10. The refrigerator of claim 1, wherein
the at least one door includes at least two doors, and
the at least one processor is further configured to, when the detected gaze point is a boundary area between doors of the at least two doors, control the door driving unit to open all doors of the at least two doors that are adjacent to the boundary area.

11. The refrigerator of claim 1, wherein
the at least one door includes at least two doors, and
the at least one processor is further configured to, after opening the determined door, when another gaze point is detected by using the image data of the user obtained by the image obtaining sensor, determine another door of the at least two doors corresponding to the detected another gaze point among unopened doors of the at least two doors, and control the door driving unit to open the determined another door.

12. A control method of a refrigerator, the control method comprising:
obtaining image data of a user located in a vicinity of the refrigerator by using an image obtaining sensor included in the refrigerator;
detecting a gaze point where a gaze of the user stays for a preset time period or longer by using the obtained image data of the user;
determining a door corresponding to the detected gaze point among at least one door included in the refrigerator; and
opening the determined door by controlling a door driving unit included in the refrigerator.

13. The control method of claim 12, wherein the opening of the determined door includes,
in a state in which the at least one door is closed, detecting a first distance value between the refrigerator and the user by using an output value of a proximity sensor included in the refrigerator, and
when the detected first distance value is greater than or equal to a first threshold value and less than a second threshold value, controlling the door driving unit to open the determined door.

14. The control method of claim 13, wherein the obtaining of the image data of the user includes,
when the detected first distance value is less than the second threshold value in a state in which the at least one door is closed, obtaining image data of the user located in the vicinity of the at least one door by activating an operation of the image obtaining sensor, and
the control method further comprises:
after the opening of the determined door, detecting a second distance value between the refrigerator and the user by using an output value of the proximity sensor; and
when the detected second distance value is greater than or equal to the second threshold value, controlling the door driving unit to close the opened door.

15. The control method of claim 14, wherein the at least one door includes at least two doors, and the control method further comprising:
deactivating the operation of the image obtaining sensor when the detected second distance value is greater than or equal to the second threshold value after opening and closing the determined door;
dividing a front of the refrigerator into a plurality of virtual gaze areas based on a number of doors of the at least two doors or a structure of the refrigerator;
detecting an area where a gaze point stays for a preset time period or longer among the plurality of virtual gaze areas as a gaze area of the front of the refrigerator including the gaze point; and
displaying, via an output unit of the refrigerator, information to guide the user about virtual gaze areas of the plurality of virtual gaze areas which the user is able to gaze at to open the at least two doors,
wherein the opening of the determined door comprises,
when the detected gaze point is a boundary area between doors of the at least two doors, controlling the door driving unit to open all doors of the at least two doors adjacent to the boundary area.
